(19) United States
(12) Patent Application Publication
(10) Pub. No.: US 2025/0023587 A1
(43) Pub. Date: Jan. 16, 2025

(54) RADIO-FREQUENCY MODULE

(71) Applicant: Murata Manufacturing Co., Ltd., Nagaokakyo-shi (JP)

(72) Inventors: Atsushi ONO, Nagaokakyo-shi (JP); Shinya HITOMI, Nagaokakyo-shi (JP); Hirotsugu MORI, Nagaokakyo-shi (JP)

(73) Assignee: Murata Manufacturing Co., Ltd., Nagaokakyo-shi (JP)

(21) Appl. No.: 18/899,361

(22) Filed: Sep. 27, 2024

Related U.S. Application Data
(63) Continuation of application No. PCT/JP2023/007844, filed on Mar. 2, 2023.

(30) Foreign Application Priority Data
Mar. 29, 2022 (JP) 2022-053222

(51) Int. Cl. H04B 1/00; H04B 7/06; H04W 88/06

(52) U.S. Cl. CPC H04B 1/0064; H04B 7/0608; H04W 88/06

(57) ABSTRACT

A radio-frequency module includes first and second power amplifiers, a first low-noise amplifier, and a first switch. Each of a first primary terminal, a second primary terminal, and a first diversity terminal of the first switch is connectable to each of a first antenna terminal, a second antenna terminal, and a second diversity terminal of the first switch. The first power amplifier connects to one of the first and second primary terminals. The second power amplifier connects to the other one of the first and second primary terminals. The first low-noise amplifier connects to the first primary terminal or the second primary terminal. The first diversity terminal is connectable to a second low-noise amplifier included in a diversity module. The second diversity terminal is connectable to a third antenna terminal included in the diversity module.

### CROSS-REFERENCE TO RELATED APPLICATIONS

This is a continuation application of PCT International Application No. PCT/JP2023/007844 filed on Mar. 2, 2023, designating the United States of America, which is based on and claims priority of Japanese Patent Application No. 2022-053222 filed on Mar. 29, 2022. The entire disclosures of the above-identified applications, including the specifications, drawings, and claims are incorporated herein by reference in their entirety.

### BACKGROUND

### 1. Field of the Disclosure

The present disclosure relates to a radio-frequency module and a communication device.

### 2. Description of the Related Art

It is desired that a multiband- and multimode-support front-end circuit transmit and receive multiple radio-frequency signals with a small loss and a high isolation.

U.S. Patent Application Publication No. 2016/0127015 discloses a receive module (radio-frequency module) in which multiple filters whose pass bands are different from each other are connected to an antenna via a multiplexer (switch).

### SUMMARY

Band combinations to be used in simultaneous transmission (ENDC (Eutra NR Dual Connectivity) and CA (Carrier Aggregation)) defined by 3GPP (registered trademark) (Third Generation Partnership Project) are increasing. In accordance with increased band combinations, the signal quality is likely to deteriorate due to intermodulation distortion. To suppress the degradation of the signal quality, it is desirable to connect multiple antennas to a radio-frequency module.

However, connecting more antennas to a radio-frequency module to support simultaneous transmission may increase the complexity of portions to be connected to the antennas and enlarge the radio-frequency module.

Accordingly, it is an aspect of the present disclosure to provide a radio-frequency module and a communication device that are reduced in size and make it less likely to degrade the signal quality during simultaneous transmission.

A radio-frequency module according to an aspect of the disclosure includes first and second power amplifiers, a first low-noise amplifier, and a first switch. The first switch includes first and second antenna terminals, first and second diversity terminals, and first and second primary terminals. Each of the first primary terminal, the second primary terminal, and the first diversity terminal is connectable to each of the first antenna terminal, the second antenna terminal, and the second diversity terminal. The first power amplifier connects to one of the first and second primary terminals. The second power amplifier connects to the other one of the first and second primary terminals. The first low-noise amplifier connects to the first primary terminal or the second primary terminal. The first diversity terminal is connectable to a second low-noise amplifier included in a diversity module, which is a module different from the radio-frequency module. The second diversity terminal is connectable to a third antenna terminal included in the diversity module.

A radio-frequency module according to an aspect of the disclosure includes a first power amplifier, a first low-noise amplifier, and a first switch. The first switch includes first and second antenna terminals, first and second diversity terminals, and first and second primary terminals. Each of the first primary terminal, the second primary terminal, and the first diversity terminal is connectable to each of the first antenna terminal, the second antenna terminal, and the second diversity terminal. The first power amplifier connects to one of the first and second primary terminals. The first low-noise amplifier connects to the first primary terminal or the second primary terminal. The first diversity terminal is connectable to a second power amplifier and a second low-noise amplifier included in a diversity module, which is a module different from the radio-frequency module. The second diversity terminal is connectable to a third antenna terminal included in the diversity module.

According to an embodiment of the disclosure, it is possible to provide a radio-frequency module and a communication device that are reduced in size and make it less likely to degrade the signal quality during simultaneous transmission.

These and other objects, advantages and features of the disclosure will become apparent from the following description thereof taken in conjunction with the accompanying drawings that illustrate a specific embodiment of the present disclosure.

### BRIEF DESCRIPTION OF THE DRAWINGS

FIG. 1 is a circuit diagram of a radio-frequency module and a communication device according to an embodiment;

FIG. 2A illustrates a circuit state of the radio-frequency module of the embodiment in a first mode;

FIG. 2B illustrates a circuit state of the radio-frequency module of the embodiment in a second mode;

FIG. 2C illustrates a circuit state of the radio-frequency module of the embodiment in a third mode;

FIG. 3A illustrates a circuit state of a radio-frequency module according to a first modified example in a fourth mode;

FIG. 3B illustrates a circuit state of the radio-frequency module of the first modified example in a fifth mode;

FIG. 3C is a circuit diagram of a radio-frequency module according to a second modified example;

FIG. 4 is a circuit diagram of a radio-frequency module and a communication device according to a third modified example;

FIG. 5 illustrates a circuit state of the radio-frequency module of the third modified example in a sixth mode; and

FIG. 6 illustrates a circuit state of a radio-frequency module according to a fourth modified example in a seventh mode.

### DESCRIPTION OF THE EMBODIMENTS

Embodiments of the disclosure will be described below in detail with reference to the accompanying drawings. Embodiments described below illustrate general or specific examples. Numerical values, shapes, materials, components, and positions and connection states of the components illustrated in the following embodiments are only examples and are not intended to limit the disclosure.

The drawings are only schematically shown and are not necessarily precisely illustrated. For the sake of representation, the drawings may be illustrated in an exaggerated manner or with omissions or the ratios of components in the drawings may be adjusted. The shapes, positional relationships, and ratios of components in the drawings may be different from those of the actual components. In the drawings, substantially identical components are designated by like reference numeral, and it may be possible that an explanation of such components be not repeated or be merely simplified.

In the disclosure, “A is connected to B” includes, not only the meaning that A is directly connected to B using a connection terminal and/or a wiring conductor, but also the meaning that A is electrically connected to B via another circuit element. “Being connected between A and B” means that “being connected to both A and B on a path which connects A and B”.

In the disclosure, “transmit path” means a transmission line constituted by wiring for transferring a radio-frequency transmission signal, an electrode directly connected to the wiring, and a terminal directly connected to the wiring or the electrode, for example. In the disclosure, “receive path” means a transmission line constituted by wiring for transferring a radio-frequency reception signal, an electrode directly connected to the wiring, and a terminal directly connected to the wiring or the electrode, for example.

In the disclosure, a first band (band A), a second band (band B), and a third band (band C) each refer to a frequency band defined by a standardizing body (such as 3GPP (registered trademark) and IEEE (Institute of Electrical and Electronics Engineers)) for a communication system to be constructed using a radio access technology (RAT). In the following embodiment and modified examples thereof, as the communication system, a LTE (Long Term Evolution) system, a 5G (5th Generation)-NR (New Radio) system, and a WLAN (Wireless Local Area Network) system, for example, may be used. However, the communication system is not limited to these types of systems.

An uplink operating band is a frequency range used for uplink communication in the first, second, and third bands. A downlink operating band is a frequency range used for downlink communication in the first, second, and third bands.

### EMBODIMENT

### [1 Circuit Configuration of Radio-Frequency Module 1 and Communication Device 5]

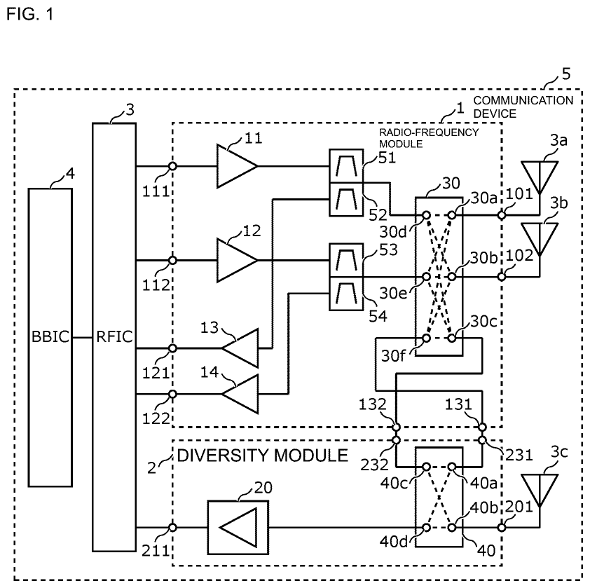

The circuit configuration of a radio-frequency module 1 and that of a communication device 5 according to an embodiment will be described below with reference to FIG. 1. FIG. 1 is a circuit diagram of the radio-frequency module 1 and the communication device 5 according to the embodiment.

### 1.1 Circuit Configuration of Communication Device 5

The circuit configuration of the communication device 5 will first be discussed below. As illustrated in FIG. 1, the communication device 5 according to the embodiment includes the radio-frequency module 1, a diversity module 2 (sometimes called diversity circuitry module), antennas 3a, 3b, and 3c, a radio-frequency (RF) signal processing circuit (RFIC) 3, and a baseband signal processing circuit (BBIC) 4.

The radio-frequency module 1 transfers a radio-frequency signal between the antennas 3a, 3b, and 3c and the RFIC 3. The detailed circuit configuration of the radio-frequency module 1 will be discussed later.

The antenna 3a is connected to an antenna connection terminal 101 of the radio-frequency module 1. The antenna 3a transmits a radio-frequency signal output from the radio-frequency module 1 and also receives a radio-frequency signal from the outside and outputs the received radio-frequency signal to the radio-frequency module 1.

The antenna 3b is connected to an antenna connection terminal 102 of the radio-frequency module 1. The antenna 3b transmits a radio-frequency signal output from the radio-frequency module 1 and also receives a radio-frequency signal from the outside and outputs the received radio-frequency signal to the radio-frequency module 1.

The antenna 3c is connected to an antenna connection terminal 201 of the diversity module 2. The antenna 3c transmits a radio-frequency signal output from the diversity module 2 and also receives a radio-frequency signal from the outside and outputs the received radio-frequency signal to the diversity module 2.

The RFIC 3 is an example of a signal processing circuit that processes a radio-frequency signal. The RFIC 3 will be explained below more specifically. The RFIC 3 can perform signal processing, such as down-conversion, on a radio-frequency reception signal, which is received via a receive path of the radio-frequency module 1 or the diversity module 2, and output the resulting reception signal to the BBIC 4. The RFIC 3 can also perform signal processing, such as up-conversion, on a transmission signal received from the BBIC 4 and output the resulting radio-frequency transmission signal to a transmit path of the radio-frequency module 1. The RFIC 3 includes a controller that controls components, such as switches and amplifiers, of the radio-frequency module 1 and the diversity module 2. All or some of the functions of the RFIC 3 as the controller may be implemented in a source outside the RFIC 3, such as in the BBIC 4, radio-frequency module 1, or diversity module 2.

In the communication device 5 of the embodiment, the diversity module 2, antennas 3a, 3b, and 3c, and BBIC 4 are not essential components.

### 1.2 Circuit Configurations of Radio-Frequency Module 1 and Diversity Module 2

The circuit configuration of the radio-frequency module 1 and that of the diversity module 2 will now be described below. As illustrated in FIG. 1, the radio-frequency module 1 is a primary module and includes power amplifiers 11 and 12, low-noise amplifiers 13 and 14, filters 51, 52, 53, and 54, a switch 30, antenna connection terminals 101 and 102, diversity connection terminals 131 and 132, radio-frequency input terminals 111 and 112, and radio-frequency output terminals 121 and 122.

The diversity module 2 includes a low-noise amplifier 20, a switch 40, an antenna connection terminal 201, primary connection terminals 231 and 232, and a radio-frequency output terminal 211.

The antenna connection terminal 101 is an external connection terminal of the radio-frequency module 1 and is connected to the antenna 3a. The antenna connection terminal 102 is an external connection terminal of the radio-frequency module 1 and is connected to the antenna 3b. The radio-frequency input terminals 111 and 112 are external connection terminals of the radio-frequency module 1 and are terminals for receiving a radio-frequency transmission signal from the RFIC 3. The radio-frequency output terminals 121 and 122 are external connection terminals of the radio-frequency module 1 and are terminals for outputting a radio-frequency reception signal to the RFIC 3. The diversity connection terminal 131 is an external connection terminal of the radio-frequency module 1 and is connected to the primary connection terminal 231 of the diversity module 2. The diversity connection terminal 132 is an external connection terminal of the radio-frequency module 1 and is connected to the primary connection terminal 232 of the diversity module 2.

The primary connection terminal 231 is an external connection terminal of the diversity module 2 and is connected to the diversity connection terminal 131 of the radio-frequency module 1. The primary connection terminal 232 is an external connection terminal of the diversity module 2 and is connected to the diversity connection terminal 132 of the radio-frequency module 1.

The power amplifier 11 is an example of a first power amplifier. The input terminal of the power amplifier 11 is connected to the radio-frequency input terminal 111, and the output terminal thereof is connected to a primary terminal 30d of the switch 30 via the filter 51. The power amplifier 12 is an example of a second power amplifier. The input terminal of the power amplifier 12 is connected to the radio-frequency input terminal 112, and the output terminal thereof is connected to a primary terminal 30e of the switch 30 via the filter 53.

The power amplifier 11 may be connected to the primary terminal 30e, while the power amplifier 12 may be connected to the primary terminal 30d.

The low-noise amplifier 13 is an example of a first low-noise amplifier. The input terminal of the low-noise amplifier 13 is connected to the primary terminal 30d via the filter 52, and the output terminal thereof is connected to the radio-frequency output terminal 121. The low-noise amplifier 14 is an example of the first low-noise amplifier. The input terminal of the low-noise amplifier 14 is connected to the primary terminal 30e via the filter 54, and the output terminal thereof is connected to the radio-frequency output terminal 122.

The input terminal of the filter 51 is connected to the power amplifier 11, and the output terminal thereof is connected to the primary terminal 30d. The input terminal of the filter 52 is connected to the primary terminal 30d, and the output terminal thereof is connected to the low-noise amplifier 13. The filters 51 and 52 form a duplexer.

The input terminal of the filter 53 is connected to the power amplifier 12, and the output terminal thereof is connected to the primary terminal 30e. The input terminal of the filter 54 is connected to the primary terminal 30e, and the output terminal thereof is connected to the low-noise amplifier 14. The filters 53 and 54 form a duplexer.

The switch 30 is an example of a first switch and has an antenna terminal 30a (first antenna terminal), an antenna terminal 30b (second antenna terminal), a diversity terminal 30c (second diversity terminal), a diversity terminal 30f (first diversity terminal), a primary terminal 30d (first primary terminal), and a primary terminal 30e (second primary terminal). Each of the primary terminal 30d, primary terminal 30e, and diversity terminal 30f is connectable to each of the antenna terminal 30a, antenna terminal 30b, and diversity terminal 30c.

The low-noise amplifier 20 is an example of a second low-noise amplifier. The input terminal of the low-noise amplifier 20 is connected to a terminal 40d of the switch 40, and the output terminal thereof is connected to the radio-frequency output terminal 211.

The switch 40 has an antenna terminal 40b (third antenna terminal) and terminals 40a, 40c, and 40d. Each of the terminals 40a and 40b is connectable to each of the terminals 40c and 40d.

The diversity terminal 30c is connected to the terminal 40c via the diversity connection terminal 132 and the primary connection terminal 232. The diversity terminal 30f is connected to the terminal 40a via the diversity connection terminal 131 and the primary connection terminal 231.

With the above-described configuration, the diversity terminal 30f can be connected to the low-noise amplifier 20 included in the diversity module 2, which is a module different from the radio-frequency module 1, while the diversity terminal 30c can be connected to the antenna terminal 40b included in the diversity module 2.

This enables the radio-frequency module 1 to use the antenna 3c directly connected to the diversity module 2 when simultaneously transmitting multiple radio-frequency signals. That is, as a result of making the antenna 3c connectable to the radio-frequency module 1, the isolation between signals to be simultaneously transferred in the radio-frequency module 1 can be secured, thereby suppressing the degradation of the signal quality caused by intermodulation distortion. Additionally, since the number of antenna connection terminals disposed in the radio-frequency module 1 is reduced, the size of the radio-frequency module 1 is less likely to be increased. It is thus possible to provide a radio-frequency module 1 that is reduced in size and makes it less likely to degrade the signal quality during simultaneous transmission.

### 1.3 Circuit State in Simultaneous Transmission Mode in Embodiment

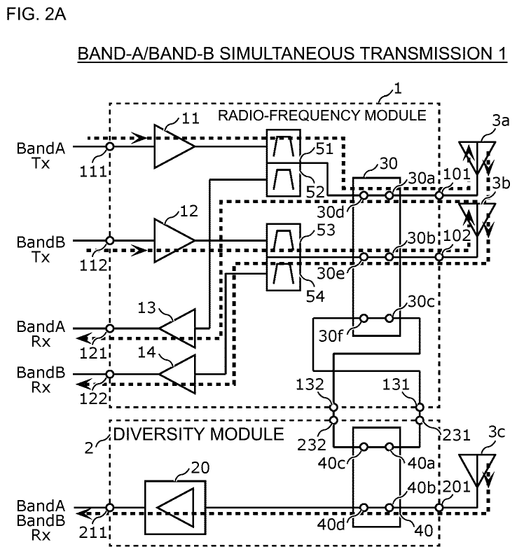

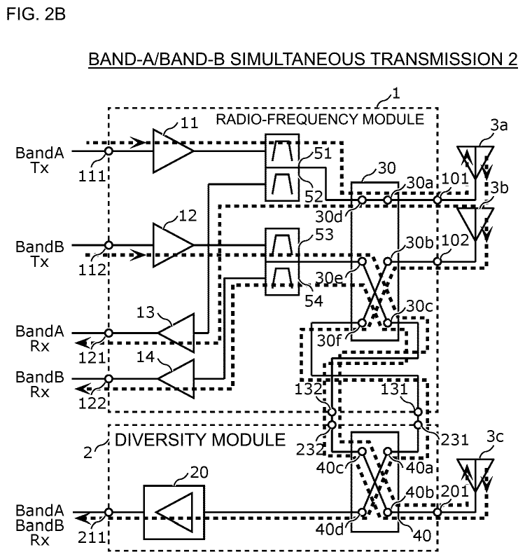

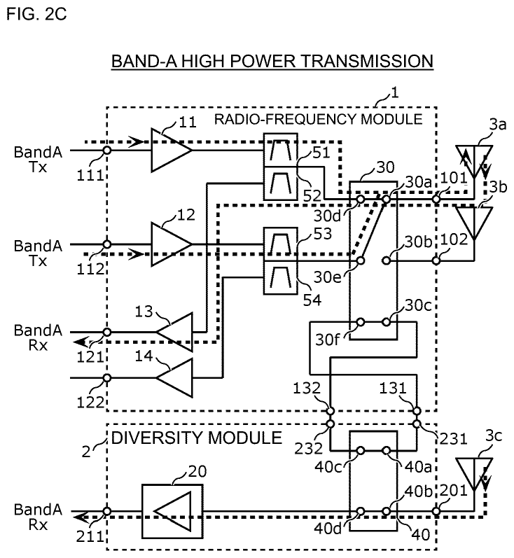

FIG. 2A illustrates a circuit state of the radio-frequency module 1 of the embodiment in a first mode. The first mode is a mode in which a transmission signal and a reception signal of band A (first band) and those of band B (second band) are simultaneously transferred, and the transmission signal of band A (first band) is output from the antenna 3a, while the transmission signal of band B (second band) is output from the antenna 3b.

In the radio-frequency module 1 executing the first mode, the states of the filters 51 through 54 are as follows. The filter 51, which is an example of a first filter and is connected between the power amplifier 11 and the primary terminal 30d, has a pass band including the uplink operating band of band A. The filter 52 has a pass band including the downlink operating band of band A. The filter 53, which is an example of a second filter and is connected between the power amplifier 12 and the primary terminal 30e, has a pass band including the uplink operating band of band B. The filter 54 has a pass band including the downlink operating band of band B.

As shown in FIG. 2A, when the first mode is executed, the connection states of the switches 30 and 40 are as follows. The antenna terminal 30a and the primary terminal 30d are connected, the antenna terminal 30b and the primary terminal 30e are connected, and the diversity terminals 30c and 30f are connected. The terminals 40a and 40c are connected, and the antenna terminal 40b and the terminal 40d are connected.

With the above-described circuit state, the transmission and reception signals of band A and those of band B are transferred in the following manner. The transmission signal of band A is transferred in a transmit path in order of the radio-frequency input terminal 111, power amplifier 11, filter 51, switch 30, antenna connection terminal 101, and antenna 3a. The reception signal of band A is transferred in a receive path in order of the antenna 3a, antenna connection terminal 101, switch 30, filter 52, low-noise amplifier 13, and radio-frequency output terminal 121.

The transmission signal of band B is transferred in a transmit path in order of the radio-frequency input terminal 112, power amplifier 12, filter 53, switch 30, antenna connection terminal 102, and antenna 3b. The reception signal of band B is transferred in a receive path in order of the antenna 3b, antenna connection terminal 102, switch 30, filter 54, low-noise amplifier 14, and radio-frequency output terminal 122.

Reception signals of band A and band B may also be output to the RFIC 3 via the antenna 3c and the diversity module 2.

FIG. 2B illustrates a circuit state of the radio-frequency module 1 of the embodiment in a second mode. The second mode is a mode in which a transmission signal and a reception signal of band A (first band) and those of band B (second band) are simultaneously transferred, and the transmission signal of band A (first band) is output from the antenna 3a, while the transmission signal of band B (second band) is output from the antenna 3c.

In the radio-frequency module 1 executing the second mode, the states of the filters 51 through 54 are as follows. The filter 51 has a pass band including the uplink operating band of band A, while the filter 52 has a pass band including the downlink operating band of band A. The filter 53 has a pass band including the uplink operating band of band B, while the filter 54 has a pass band including the downlink operating band of band B.

As shown in FIG. 2B, when the second mode is executed, the connection states of the switches 30 and 40 are as follows. The antenna terminal 30a and the primary terminal 30d are connected, the antenna terminal 30b and the diversity terminal 30f are connected, and the diversity terminal 30c and the primary terminal 30e are connected. The terminals 40a and 40d are connected, and the antenna terminal 40b and the terminal 40c are connected.

With the above-described circuit state, the transmission and reception signals of band A and those of band B are transferred in the following manner. The transmission signal of band A is transferred in a transmit path in order of the radio-frequency input terminal 111, power amplifier 11, filter 51, switch 30, antenna connection terminal 101, and antenna 3a. The reception signal of band A is transferred in a receive path in order of the antenna 3a, antenna connection terminal 101, switch 30, filter 52, low-noise amplifier 13, and radio-frequency output terminal 121.

The transmission signal of band B is transferred in a transmit path in order of the radio-frequency input terminal 112, power amplifier 12, filter 53, switch 30, diversity connection terminal 132, primary connection terminal 232, switch 40, antenna connection terminal 201, and antenna 3c. The reception signal of band B is transferred in a receive path in order of the antenna 3c, antenna connection terminal 201, switch 40, primary connection terminal 232, diversity connection terminal 132, switch 30, filter 54, low-noise amplifier 14, and radio-frequency output terminal 122.

Reception signals of band A and band B may also be output to the RFIC 3 via the antenna 3b, antenna connection terminal 102, switch 30, diversity connection terminal 131, and diversity module 2.

In the first mode and the second mode, it is possible to perform simultaneous transmission (ENDC or Inter-band CA) of a transmission signal of band A amplified in the power amplifier 11 and a transmission signal of band B amplified in the power amplifier 12. Even with a band combination which causes intermodulation distortion, the isolation can be secured by performing transmission using different antennas.

In simultaneous transmission of a transmission signal of band A and that of band B, in accordance with the state of the antenna sensitivity, it is possible to select one of (1) simultaneous transmission of a transmission signal of band A and that of band B using the antennas 3a and 3b directly connected to the radio-frequency module 1 and (2) simultaneous transmission of a transmission signal of band A and that of band B using the antenna 3a directly connected to the radio-frequency module 1 and the antenna 3c directly connected to the diversity module 2.

When performing simultaneous transmission of a transmission signal of band A and that of band B, the connection state of the switch 30 is not limited to that in the first mode or that in the second mode. The switch 30 may be in any desired connection state if the following conditions are satisfied: the primary terminal 30d is connected to any one of the antenna terminal 30a, antenna terminal 30b, and diversity terminal 30c; the primary terminal 30e is connected to one of the antenna terminal 30a, antenna terminal 30b, and diversity terminal 30c which is not connected to the primary terminal 30d; and the diversity terminal 30f is connected to one of the antenna terminal 30a, antenna terminal 30b, and diversity terminal 30c which is neither connected to the primary terminal 30d nor the primary terminal 30e.

With this configuration, when performing simultaneous transmission of a transmission signal of band A amplified in the power amplifier 11 and a transmission signal of band B amplified in the power amplifier 12, even with a band combination which causes intermodulation distortion, the isolation can be secured by suitably selecting two of the three antennas.

In both of the first mode and the second mode, in one example, band A is band B8 for LTE or band n8 for 5G-NR, while band B is band B20 for LTE or band n20 for 5G-NR.

In both of the first mode and the second mode, in another example, band A is band B13 for LTE or band n13 for 5G-NR, while band B is band B26 for LTE or band n26 for 5G-NR.

In both of the first mode and the second mode, in another example, band A is band B2 for LTE or band n2 for 5G-NR, while band B is band B66 for LTE or band n66 for 5G-NR.

In both of the first mode and the second mode, in another example, band A is band B8 for LTE or band n8 for 5G-NR, while band B is band B1 or B3 for LTE or band n1 or n3 for 5G-NR.

In both of the first mode and the second mode, in another example, band A is band B1 for LTE or band n1 for 5G-NR, while band B is band B3 for LTE or band n3 for 5G-NR.

In the above-described band combinations, a frequency range in which intermodulation distortion occurs due to the interference of a transmission signal of band A and that of band B overlaps the receive band of band A or band B. However, the isolation can be secured by the use of different antennas, thereby suppressing the degradation of the reception sensitivity caused by intermodulation distortion.

In both of the first mode and the second mode, the power amplifier 11 may amplify a signal of one of LTE and 5G-NR, and the power amplifier 12 may amplify a signal of the other one of LTE and 5G-NR.

With this configuration, when ENDC transmission is performed, the antennas 3a and 3b directly connected to the radio-frequency module 1 and the antenna 3c directly connected to the diversity module 2 are compared with each other, and the antennas 3a and 3b or the antenna 3c having a higher sensitivity can be used to transmit an LTE signal.

In both of the first mode and the second mode, the radio-frequency module 1 is able to transmit a signal of a power class whose maximum output power is higher than or equal to the maximum output power of power class 2. The power class that the power amplifier 11 can support and the power class that the power amplifier 12 can support may be different from each other.

With this configuration, the radio-frequency module 1 is able to transmit a transmission signal of a high power class (power class 2 or higher).

The power class is the classification of output power of user equipment (UE), which is defined by the maximum output power of the UE, for example. As the value of the power class is smaller, output power is higher. For example, 3GPP (registered trademark) defines the values of the maximum output power of the individual power classes as follows: power class 1 is 31 dBm; power class 1.5 is 29 dBm; power class 2 is 26 dBm; and power class 3 is 23 dBm.

The maximum output power of UE is determined by the output power at the end portion of the antenna of the UE. The maximum output power of UE is measured by a method defined by 3GPP (registered trademark), for example. For instance, in FIG. 2C, the maximum output power can be determined by measuring radiation power of the antenna 3a. Instead of measuring radiation power, the output power of the antenna 3a may be measured by using a measurement instrument, such as a spectrum analyzer, connected to a terminal provided near the antenna 3a.

FIG. 2C illustrates a circuit state of the radio-frequency module 1 of the embodiment in a third mode. The third mode is a mode in which a transmission signal of band A (first band) is output in a high power mode.

In the radio-frequency module 1 executing the third mode, each of the filters 51 and 53 has a pass band including the uplink operating band of band A, while each of the filters 52 and 54 has a pass band including the downlink operating band of band A. The radio-frequency module 1 executing the third mode is able to transmit a signal of a power class whose maximum output power is higher than or equal to the maximum output power of power class 2.

As shown in FIG. 2C, when the third mode is executed, the connection states of the switches 30 and 40 are as follows. The antenna terminal 30a and the primary terminal 30d are connected, the antenna terminal 30a and the primary terminal 30e are also connected, and the diversity terminals 30c and 30f are connected. The terminals 40a and 40c are connected, and the antenna terminal 40b and the terminal 40d are connected.

With the above-described circuit state, a first transmission signal of a first channel of band A is transferred in a transmit path in order of the radio-frequency input terminal 111, power amplifier 11, filter 51, switch 30, antenna connection terminal 101, and antenna 3a. A second transmission signal of the first channel of band A is transferred in a transmit path in order of the radio-frequency input terminal 112, power amplifier 12, filter 53, switch 30, antenna connection terminal 101, and antenna 3a.

Each of the first transmission signal and the second transmission signal is a signal of power class 3, for example. Power of the first transmission signal and that of the second transmission signal are combined in the antenna 3a, and the resulting transmission signal of band A of power class 2 is output from the antenna 3a.

With this configuration, by using multiple transmit paths of the radio-frequency module 1 at the same time, even if neither of the power amplifier 11 nor the power amplifier 12 supports a high power class (power class 2 or higher), a transmission signal of a high power class (power class 2 or higher) can be transmitted.

A reception signal of band A is transferred in a receive path in order of the antenna 3a, antenna connection terminal 101, switch 30, filter 52, low-noise amplifier 13, and radio-frequency output terminal 121. Additionally, a reception signal of band A may also be output to the RFIC 3 via the antenna 3c and the diversity module 2.

In the third mode, the power amplifier 11 may amplify a first channel signal of band A, while the power amplifier 12 may amplify a second channel signal of band A. The first channel signal of band A amplified in the power amplifier 11 may be output from the antenna 3a, while the second channel signal of band A amplified in the power amplifier 12 may be output from the antenna 3b or 3c.

With this configuration, the radio-frequency module 1 can support simultaneous transmission of the same band (Intra-band_CA or Intra-band ENDC).

### 1.4 Circuit Configuration of Radio-Frequency Module 1A of First Modified Example

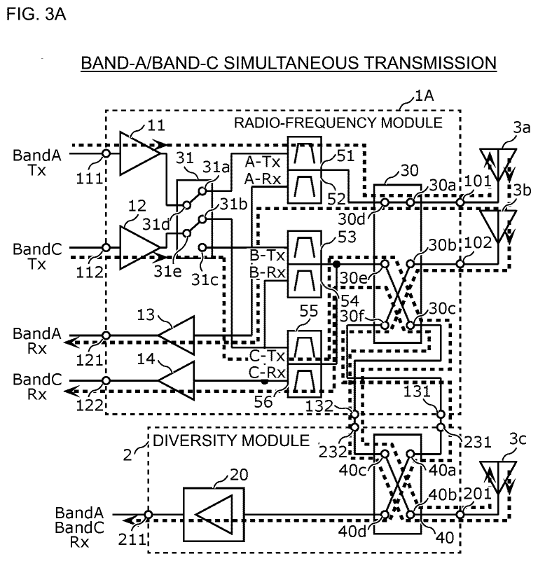

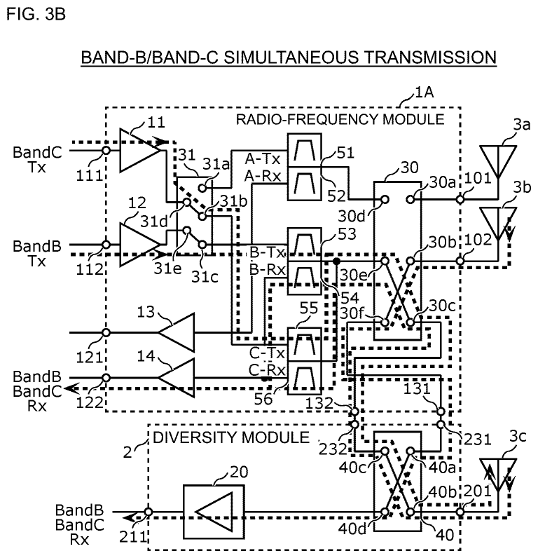

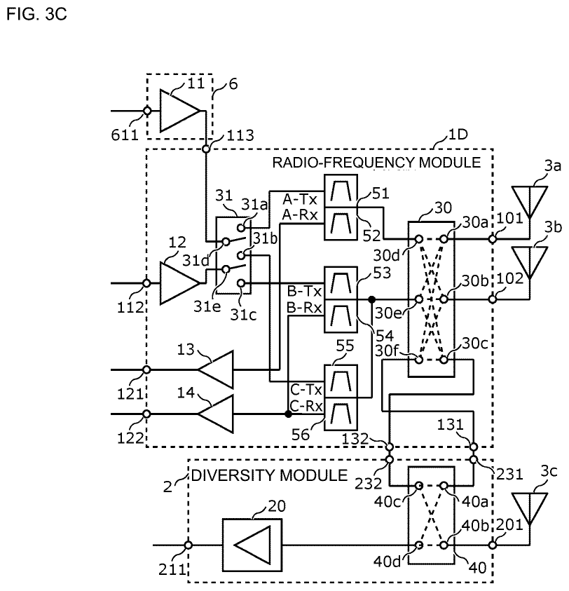

FIG. 3A illustrates a circuit state of a radio-frequency module 1A according to a first modified example in a fourth mode. FIG. 3B illustrates a circuit state of the radio-frequency module 1A of the first modified example in a fifth mode. The fourth mode is a mode in which a transmission signal and a reception signal of band A (first band) and those of band C (third band) are simultaneously transferred, and the transmission signal of band A (first band) is output from the antenna 3a, while the transmission signal of band C (third band) is output from the antenna 3c. The fifth mode is a mode in which a transmission signal and a reception signal of band B (second band) and those of band C (third band) are simultaneously transferred, and the transmission signal of band B (second band) is output from the antenna 3c, while the transmission signal of band C (third band) is output from the antenna 3c.

As illustrated in FIGS. 3A and 3B, the radio-frequency module 1A is a primary module and includes power amplifiers 11 and 12, low-noise amplifiers 13 and 14, filters 51, 52, 53, 54, 55, and 56, switches 30 and 31, antenna connection terminals 101 and 102, diversity connection terminals 131 and 132, radio-frequency input terminals 111 and 112, and radio-frequency output terminals 121 and 122.

The diversity module 2 includes a low-noise amplifier 20, a switch 40, an antenna connection terminal 201, primary connection terminals 231 and 232, and a radio-frequency output terminal 211.

The radio-frequency module 1A of the first modified example is different from the radio-frequency module 1 of the embodiment mainly in that the filters 55 and 56 and the switch 31 are added. The radio-frequency module 1A of the first modified example will be described below mainly by referring to the points different from the radio-frequency module 1 while omitting the same points as the radio-frequency module 1.

The power amplifier 11 is an example of the first power amplifier. The input terminal of the power amplifier 11 is connected to the radio-frequency input terminal 111, and the output terminal thereof is connected to the primary terminal 30d via the switch 31 and the filter 51 and is also connected to the primary terminal 30e via the switch 31 and the filter 55. The power amplifier 12 is an example of the second power amplifier. The input terminal of the power amplifier 12 is connected to the radio-frequency input terminal 112, and the output terminal thereof is connected to the primary terminal 30e via the switch 31 and the filter 53 and is also connected to the primary terminal 30e via the switch 31 and the filter 55.

The low-noise amplifier 13 is an example of the first low-noise amplifier. The input terminal of the low-noise amplifier 13 is connected to the primary terminal 30d via the filter 52, and the output terminal thereof is connected to the radio-frequency output terminal 121. The low-noise amplifier 14 is an example of the first low-noise amplifier. The input terminal of the low-noise amplifier 14 is connected to the primary terminal 30e via the filter 54 and is also connected to the primary terminal 30e via the filter 56, and the output terminal thereof is connected to the radio-frequency output terminal 122.

The filter 51 is an example of the first filter. The input terminal of the filter 51 is connected to a terminal 31a of the switch 31, and the output terminal thereof is connected to the primary terminal 30d. The input terminal of the filter 52 is connected to the primary terminal 30d, and the output terminal thereof is connected to the low-noise amplifier 13. The filters 51 and 52 form a duplexer.

The filter 53 is an example of the second filter. The input terminal of the filter 53 is connected to a terminal 31c of the switch 31, and the output terminal thereof is connected to the primary terminal 30e. The input terminal of the filter 54 is connected to the primary terminal 30e, and the output terminal thereof is connected to the low-noise amplifier 14. The filters 53 and 54 form a duplexer.

The filter 55, which is an example of a third filter, is connected between the power amplifiers 11 and 12 and the primary terminal 30e and has a pass band including band C (third band). More specifically, the input terminal of the filter 55 is connected to a terminal 31b of the switch 31, and the output terminal thereof is connected to the primary terminal 30e. The input terminal of the filter 56 is connected to the primary terminal 30e, and the output terminal thereof is connected to the low-noise amplifier 14. The filters 55 and 56 form a duplexer.

The switch 31 has terminals 31a, 31b, 31c, 31d, and 31e. The switch 31 selectively connects the terminal 31d to one of the terminals 31a and 31b and also selectively connects the terminal 31e to one of the terminals 31b and 31c.

With this configuration, the radio-frequency module 1A can use the antenna 3c directly connected to the diversity module 2 when performing simultaneous transmission of a transmission signal of band A and that of band C or a transmission signal of band B and that of band C. That is, as a result of making the antenna 3c connectable to the radio-frequency module 1A, the isolation between signals to be simultaneously transferred in the radio-frequency module 1A can be secured, thereby suppressing the degradation of the signal quality caused by intermodulation distortion. Additionally, since the number of antenna connection terminals disposed in the radio-frequency module 1A is reduced, the size of the radio-frequency module 1A is less likely to be increased. It is thus possible to provide a radio-frequency module 1A that is reduced in size and makes it less likely to degrade the signal quality during simultaneous transmission.

In the radio-frequency module 1A of the first modified example, in one example, band A is band B8 for LTE or band n8 for 5G-NR; Band B is band B20 for LTE or band n20 for 5G-NR; and Band C is band B28 for LTE or band n28 for 5G-NR.

In the above-described band combinations, simultaneous transmission modes (1) ENDC of band B8 for LTE and band n28 for 5G-NR, (2) ENDC of band B28 for LTE and band n8 for 5G-NR, (3) CA of band n8 for 5G-NR and band n28 for 5G-NR, (4) ENDC of band B20 for LTE and band n28 for 5G-NR, (5) ENDC of band B28 for LTE and band n20 for 5G-NR, and (6) CA of band n20 for 5G-NR and band n28 for 5G-NR can be implemented while securing the isolation by the use of different antennas.

In FIG. 3A, the circuit state in the simultaneous transmission modes (1), (2), and (3) is shown. In FIG. 3B, the circuit state in the simultaneous transmission modes of (4), (5), and (6) is shown.

In the radio-frequency module 1A of the first modified example, in one example, band A is band B2 for LTE or band n2 for 5G-NR, while band B is band B66 for LTE or band n66 for 5G-NR. In another example, band A is band B8 for LTE or band n8 for 5G-NR, while band B is band B1 or B3 for LTE or band n1 or n3 for 5G-NR. In another example, band A is band B1 for LTE or band n1 for 5G-NR, while band B is band B3 for LTE or band n3 for 5G-NR.

In the radio-frequency module 1A of the first modified example, when band A or band B is band B1, B3, or B66 for LTE or band n1, n3, or n66 for 5G-NR, band C may be band B4, B25, B34, B39, or B70 for LTE or band n4, n25, n34, n39, or n70 for 5G-NR, for example.

As shown in FIG. 3A, when the fourth mode is executed, the connection states of the switches 30, 31, and 40 are as follows. The antenna terminal 30a and the primary terminal 30d are connected, the antenna terminal 30b and the diversity terminal 30f are connected, and the diversity terminal 30c and the primary terminal 30e are connected. The terminals 31a and 31d are connected, and the terminals 31b and 31e are connected. The terminals 40a and 40d are connected, and the antenna terminal 40b and the terminal 40c are connected.

With the above-described circuit state, a transmission signal of band A is transferred in a transmit path in order of the radio-frequency input terminal 111, power amplifier 11, switch 31, filter 51, switch 30, antenna connection terminal 101, and antenna 3a. A reception signal of band A is transferred in a receive path in order of the antenna 3a, antenna connection terminal 101, switch 30, filter 52, low-noise amplifier 13, and radio-frequency output terminal 121.

A transmission signal of band C is transferred in a transmit path in order of the radio-frequency input terminal 112, power amplifier 12, switch 31, filter 55, switch 30, diversity connection terminal 132, primary connection terminal 232, switch 40, antenna connection terminal 201, and antenna 3c. A reception signal of band C is transferred in a receive path in order of the antenna 3c, antenna connection terminal 201, switch 40, primary connection terminal 232, diversity connection terminal 132, switch 30, filter 56, low-noise amplifier 14, and radio-frequency output terminal 122.

Reception signals of band A and band C may also be output to the RFIC 3 via the antenna 3b, antenna connection terminal 102, switch 30, diversity connection terminal 131, and diversity module 2.

As shown in FIG. 3B, when the fifth mode is executed, the connection states of the switches 30, 31, and 40 are as follows. The antenna terminal 30b and the diversity terminal 30f are connected, and the diversity terminal 30c and the primary terminal 30e are connected. The terminals 31b and 31d are connected, and the terminals 31c and 31e are connected. The terminals 40a and 40d are connected, and the antenna terminal 40b and the terminal 40c are connected.

With the above-described circuit state, a transmission signal of band B is transferred in a transmit path in order of the radio-frequency input terminal 112, power amplifier 12, switch 31, filter 53, switch 30, diversity connection terminal 132, primary connection terminal 232, switch 40, antenna connection terminal 201, and antenna 3c. A reception signal of band B is transferred in a receive path in order of the antenna 3c, antenna connection terminal 201, switch 40, primary connection terminal 232, diversity connection terminal 132, switch 30, filter 54, low-noise amplifier 14, and radio-frequency output terminal 122.

A transmission signal of band C is transferred in a transmit path in order of the radio-frequency input terminal 111, power amplifier 11, switch 31, filter 55, switch 30, diversity connection terminal 132, primary connection terminal 232, switch 40, antenna connection terminal 201, and antenna 3c. A reception signal of band C is transferred in a receive path in order of the antenna 3c, antenna connection terminal 201, switch 40, primary connection terminal 232, diversity connection terminal 132, switch 30, filter 56, low-noise amplifier 14, and radio-frequency output terminal 122.

Reception signals of band B and band C may also be output to the RFIC 3 via the antenna 3b, antenna connection terminal 102, switch 30, diversity connection terminal 131, and diversity module 2.

In the band combinations in the above-described simultaneous transmission modes (1), (2), and (3), intermodulation distortion caused by the interference of a transmission signal of band A and that of band C degrades the reception sensitivity of band A and band C. The transmission signal of band A and that of band C are thus output from the different antennas 3a and 3c, as shown in FIG. 3A.

In contrast, in the band combinations in the above-described simultaneous transmission modes (4), (5), and (6), intermodulation distortion caused by the interference of a transmission signal of band B and that of band C does not influence the reception sensitivity of band B and band C. The transmission signal of band B and that of band C are thus output from the same antenna 3c, as shown in FIG. 3B.

That is, in simultaneous transmission of transmission signals of two bands, in accordance with the state of the degradation of the reception sensitivity caused by intermodulation distortion, the antennas 3a and 3b directly connected to the radio-frequency module 1A and the antenna 3c directly connected to the diversity module 2 can suitably be selected.

The provision of the power amplifier 11 or 12 for a radio-frequency module of an embodiment of the disclosure may be omitted.

FIG. 3C is a circuit diagram of a radio-frequency module 1D according to a second modified example. As illustrated in FIG. 3C, the radio-frequency module 1D is a primary module and includes a power amplifier 12, low-noise amplifiers 13 and 14, filters 51, 52, 53, 54, 55, and 56, switches 30 and 31, antenna connection terminals 101 and 102, diversity connection terminals 131 and 132, radio-frequency input terminals 111, 112, and 113, and radio-frequency output terminals 121 and 122.

The diversity module 2 includes a low-noise amplifier 20, a switch 40, an antenna connection terminal 201, primary connection terminals 231 and 232, and a radio-frequency output terminal 211.

The radio-frequency module 1D of the second modified example is different from the radio-frequency module 1A of the first modified example in that the power amplifier 11 is included in a module 6 different from the radio-frequency module 1D. The radio-frequency module 1D of the second modified example will be described below mainly by referring to the points different from the radio-frequency module 1A while omitting the same points as the radio-frequency module 1A.

The power amplifier 11 is an example of the first power amplifier and is included in the module 6 different from the radio-frequency module 1D. The module 6 is a different unit separately provided from the radio-frequency module 1D, and the power amplifier 11 is disposed on a module laminate different from that forming the radio-frequency module 1D. Alternatively, the power amplifier 11 is disposed in a package different from that forming the radio-frequency module 1D.

The input terminal of the power amplifier 11 is connected to a radio-frequency input terminal 611, and the output terminal thereof is connected to the primary terminal 31d of the switch 31 via the radio-frequency input terminal 113. The power amplifier 11 amplifies a radio-frequency signal input from the radio-frequency input terminal 611 and outputs the amplified radio-frequency signal to the radio-frequency input terminal 113.

With the above-described configuration, the radio-frequency module 1D can use the antenna 3c directly connected to the diversity module 2 when simultaneously transmitting multiple radio-frequency signals. That is, as a result of making the antenna 3c connectable to the radio-frequency module 1D, the isolation between signals to be simultaneously transferred in the radio-frequency module 1D can be secured, thereby suppressing the degradation of the signal quality caused by intermodulation distortion. Additionally, since the number of antenna connection terminals disposed in the radio-frequency module 1D is reduced, the size of the radio-frequency module 1D is less likely to be increased. It is thus possible to provide a radio-frequency module 1D that is reduced in size and makes it less likely to degrade the signal quality during simultaneous transmission.

In the radio-frequency module 1D, instead of the power amplifier 11, the power amplifier 12 may be disposed in the module 6 different from the radio-frequency module 1D and the power amplifier 11 may be disposed in the radio-frequency module 1D.

### 1.5 Circuit Configuration of Radio-Frequency Module 1B of Third Modified Example

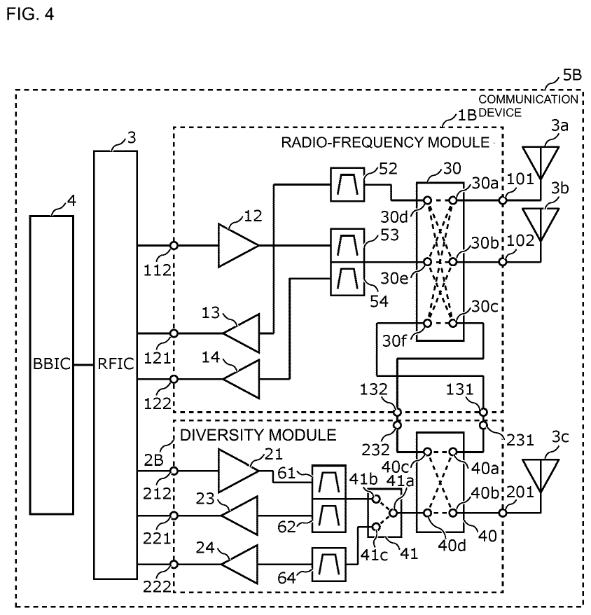

FIG. 4 is a circuit diagram of a radio-frequency module 1B and a communication device 5B according to a third modified example. As illustrated in FIG. 4, the communication device 5B includes a radio-frequency module 1B, a diversity module 2B, antennas 3a, 3b, and 3c, an RFIC 3, and a BBIC 4. The communication device 5B of the third modified example is different from the communication device 5 of the embodiment in the configuration of the radio-frequency module 1B and that of the diversity module 2B. The communication device 5B of the third modified example will be explained below mainly by referring to the configuration of the radio-frequency module 1B and the diversity module 2B.

As illustrated in FIG. 4, the radio-frequency module 1B is a primary module and includes a power amplifier 12, low-noise amplifiers 13 and 14, filters 52, 53, and 54, a switch 30, antenna connection terminals 101 and 102, diversity connection terminals 131 and 132, a radio-frequency input terminal 112, and radio-frequency output terminals 121 and 122.

The diversity module 2B includes a power amplifier 21, low-noise amplifiers 23 and 24, filters 61, 62, and 64, switches 40 and 41, an antenna connection terminal 201, primary connection terminals 231 and 232, a radio-frequency input terminal 212, and radio-frequency output terminals 221 and 222.

The radio-frequency module 1B of the third modified example is different from the radio-frequency module 1 of the embodiment in that the power amplifier 11 and the filter 51 are omitted. The diversity module 2B of the third modified example is different from the diversity module 2 of the embodiment in that the power amplifier 21, filters 61, 62, and 64, and switch 41 are added and the low-noise amplifiers 23 and 24 are provided instead of the low-noise amplifier 20. The radio-frequency module 1B and the diversity module 2B of the third modified example will be described below mainly by referring to the points different from the radio-frequency module 1 and the diversity module 2 while omitting the same points as the radio-frequency module 1 and the diversity module 2.

The power amplifier 12 is an example of the first power amplifier. The input terminal of the power amplifier 12 is connected to the radio-frequency input terminal 112, and the output terminal thereof is connected to the primary terminal 30e via the filter 53.

The low-noise amplifier 13 is an example of the first low-noise amplifier. The input terminal of the low-noise amplifier 13 is connected to the primary terminal 30d via the filter 52, and the output terminal thereof is connected to the radio-frequency output terminal 121. The low-noise amplifier 14 is an example of the first low-noise amplifier. The input terminal of the low-noise amplifier 14 is connected to the primary terminal 30e via the filter 54, and the output terminal thereof is connected to the radio-frequency output terminal 122.

The input terminal of the filter 52 is connected to the primary terminal 30d, and the output terminal thereof is connected to the low-noise amplifier 13. The input terminal of the filter 53 is connected to the power amplifier 12, and the output terminal thereof is connected to the primary terminal 30e. The input terminal of the filter 54 is connected to the primary terminal 30e, and the output terminal thereof is connected to the low-noise amplifier 14. The filters 53 and 54 form a duplexer.

The low-noise amplifier 23 is an example of the second low-noise amplifier. The input terminal of the low-noise amplifier 23 is connected to a terminal 41b of the switch 41 via the filter 62, and the output terminal thereof is connected to the radio-frequency output terminal 221. The low-noise amplifier 24 is an example of the second low-noise amplifier. The input terminal of the low-noise amplifier 24 is connected to a terminal 41c of the switch 41 via the filter 64, and the output terminal thereof is connected to the radio-frequency output terminal 222.

The power amplifier 21 is an example of the second power amplifier. The input terminal of the power amplifier 21 is connected to the radio-frequency input terminal 212, and the output terminal thereof is connected to the terminal 41b of the switch 41 via the filter 61.

The switch 41 has terminals 41a, 41b, and 41c. The switch 41 selectively connects the terminals 41a and 41b with each other or disconnects them from each other, and selectively connects the terminals 41a and 41c with each other or disconnects them from each other. The terminal 41a is connected to the terminal 40d of the switch 40. The terminal 41b is connected to the output terminal of the filter 61 and the input terminal of the filter 62. The terminal 41c is connected to the input terminal of the filter 64.

With the above-described configuration, the diversity terminal 30f can be connected to the power amplifier 21 and the low-noise amplifiers 23 and 24 included in the diversity module 2B, which is different from the radio-frequency module 1B, while the diversity terminal 30c can be connected to the antenna terminal 40b included in the diversity module 2B.

With this configuration, the radio-frequency module 1B can use the power amplifier 21 included in the diversity module 2B and the antenna 3c directly connected to the diversity module 2B when simultaneously transmitting multiple radio-frequency signals. That is, as a result of making the power amplifier 21 and the antenna 3c connectable to the radio-frequency module 1B, the isolation between signals to be simultaneously transferred in the radio-frequency module 1B can be secured, thereby suppressing the degradation of the signal quality caused by intermodulation distortion. Additionally, since the number of power amplifiers and that of antenna connection terminals disposed in the radio-frequency module 1B are reduced, the size of the radio-frequency module 1B is less likely to be increased. It is thus possible to provide a radio-frequency module 1B that is reduced in size and makes it less likely to degrade the signal quality during simultaneous transmission.

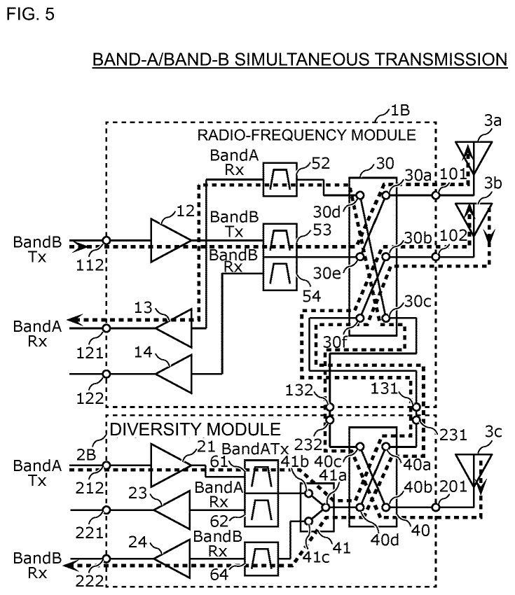

FIG. 5 illustrates a circuit state of the radio-frequency module 1B of the third modified example in a sixth mode. The sixth mode is a mode in which a transmission signal and a reception signal of band A (first band) and those of band B (second band) are simultaneously transferred, and the transmission signal of band A (first band) is output from the power amplifier 21, while the transmission signal of band B (second band) is output from the power amplifier 12.

In the radio-frequency module 1B of the third modified example, band A is band B8 for LTE or band n8 for 5G-NR, for example; and Band B is band B20 for LTE or band n20 for 5G-NR, for example. In the above-described band combinations, simultaneous transmission modes (1) ENDC of band B8 for LTE and band n20 for 5G-NR, (2) ENDC of band B20 for LTE and band n8 for 5G-NR, and (3) CA of band n8 for 5G-NR and band n28 for 5G-NR can be implemented by the use of the power amplifier 21 included in the diversity module 2B.

As shown in FIG. 5, when the sixth mode is executed, the connection states of the switches 30, 40, and 41 are as follows. The antenna terminal 30a and the primary terminal 30e are connected, the antenna terminal 30b and the diversity terminal 30f are connected, and the diversity terminal 30c and the primary terminal 30d are connected. The terminals 40a and 40d are connected, and the antenna terminal 40b and the terminal 40c are connected. The terminals 41a and 41b are connected, and the terminals 41a and 41c are connected.

With the above-described circuit state, a transmission signal of band A is transferred in a transmit path in order of the radio-frequency input terminal 212, power amplifier 21, filter 61, switch 41, switch 40, primary connection terminal 231, diversity connection terminal 131, switch 30, antenna connection terminal 102, and antenna 3b. A reception signal of band A is transferred in a receive path in order of the antenna 3c, antenna connection terminal 201, switch 40, primary connection terminal 232, diversity connection terminal 132, switch 30, filter 52, low-noise amplifier 13, and radio-frequency output terminal 121.

A transmission signal of band B is transferred in a transmit path in order of the radio-frequency input terminal 112, power amplifier 12, filter 53, switch 30, antenna connection terminal 101, and antenna 3a. A reception signal of band B is transferred in a receive path in order of the antenna 3b, antenna connection terminal 102, switch 30, diversity connection terminal 131, primary connection terminal 231, switch 40, switch 41, filter 64, low-noise amplifier 24, and radio-frequency output terminal 222.

As illustrated in FIG. 5, when simultaneously transmitting a transmission signal of band A and that of band B, the radio-frequency module 1B can use the power amplifier 12 included in the radio-frequency module 1B and the power amplifier 21 included in the diversity module 2B. That is, since the number of power amplifiers disposed in the radio-frequency module 1B is reduced, the size of the radio-frequency module 1B is less likely to be increased. Additionally, simultaneous transmission using both of the power amplifier 21 of the diversity module 2B and the power amplifier 12 of the radio-frequency module 1B is implemented, thereby lowering the heat generation in the radio-frequency module 1B.

### 1.6 Circuit Configuration of Radio-Frequency Module 1C of Fourth Modified Example

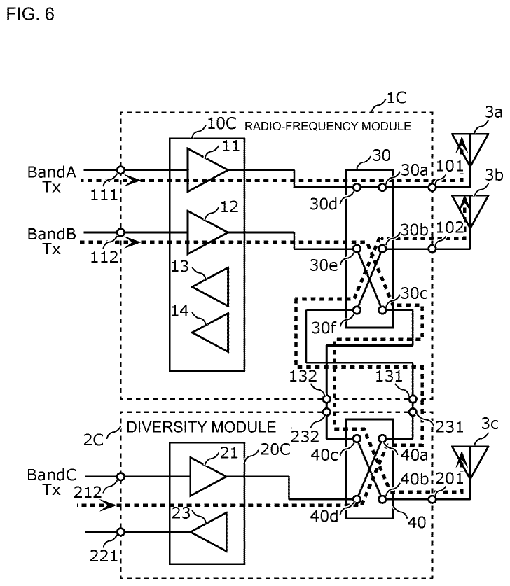

FIG. 6 is a circuit diagram of a radio-frequency module 1C according to a fourth modified example. As illustrated in FIG. 6, the radio-frequency module 1C is a primary module and includes power amplifiers 11 and 12, low-noise amplifiers 13 and 14, a switch 30, antenna connection terminals 101 and 102, diversity connection terminals 131 and 132, and radio-frequency input terminals 111 and 112. The diversity module 2C includes a power amplifier 21, a low-noise amplifier 23, a switch 40, an antenna connection terminal 201, primary connection terminals 231 and 232, a radio-frequency input terminal 212, and a radio-frequency output terminal 221.

The radio-frequency module 1C of the fourth modified example is different from the radio-frequency module 1B of the third modified example in that the power amplifier 11 is added and the filters are omitted. The diversity module 2C of the fourth modified example is different from the diversity module 2B of the third modified example in that the low-noise amplifier 24 and switch 41 are omitted and the filters are also omitted. The radio-frequency module 1C and the diversity module 2C of the fourth modified example will be described below mainly by referring to the points different from the radio-frequency module 1B and the diversity module 2B while omitting the same points as the radio-frequency module 1B and the diversity module 2B.

The power amplifier 11 is an example of a third power amplifier. The input terminal of the power amplifier 11 is connected to the radio-frequency input terminal 111, and the output terminal thereof is connected to the primary terminal 30d.

The power amplifier 12 is an example of the first power amplifier. The input terminal of the power amplifier 12 is connected to the radio-frequency input terminal 112, and the output terminal thereof is connected to the primary terminal 30e.

The power amplifier 21 is an example of the second power amplifier. The input terminal of the power amplifier 21 is connected to the radio-frequency input terminal 212, and the output terminal thereof is connected to the terminal 40d of the switch 40.

The output terminal of the power amplifier 12 may be connected to the primary terminal 30d, while the output terminal of the power amplifier 11 may be connected to the primary terminal 30e.

With this configuration, when simultaneously transmitting multiple radio-frequency signals of different bands, the radio-frequency module 1C can use the power amplifiers 11 and 12 included in the radio-frequency module 1C and the power amplifier 21 included in the diversity module 2C. It is thus possible to provide a small radio-frequency module 1C that can simultaneously transmit three transmission signals (three uplink signals) and makes it less likely to degrade the signal quality during simultaneous transmission.

FIG. 6 also illustrates a circuit state of the radio-frequency module 1C of the fourth modified example in a seventh mode. The seventh mode is a mode in which a transmission signal of band A (first band), that of band B (second band), and that of band C (third band) are simultaneously transmitted.

As shown in FIG. 6, when the seventh mode is executed, the connection states of the switches 30 and 40 are as follows. The antenna terminal 30a and the primary terminal 30d are connected, the antenna terminal 30b and the diversity terminal 30f are connected, and the diversity terminal 30c and the primary terminal 30e are connected. The terminals 40a and 40d are connected, and the antenna terminal 40b and the terminal 40c are connected.

With the above-described circuit state, a transmission signal of band A is transferred in a transmit path in order of the radio-frequency input terminal 111, power amplifier 11, switch 30, antenna connection terminal 101, and antenna 3a. A transmission signal of band B is transferred in a transmit path in order of the radio-frequency input terminal 112, power amplifier 12, switch 30, diversity connection terminal 132, primary connection terminal 232, switch 40, antenna connection terminal 201, and antenna 3c. A transmission signal of band C is transferred in a transmit path in order of the radio-frequency input terminal 212, power amplifier 21, switch 40, primary connection terminal 231, diversity connection terminal 131, switch 30, antenna connection terminal 102, and antenna 3b.

### 2 Advantages and Others

As described above, a radio-frequency module 1 according to the embodiment includes power amplifiers 11 and 12, a low-noise amplifier 13, and a switch 30. The switch 30 includes antenna terminals 30a and 30b, diversity terminals 30c and 30f, and primary terminals 30d and 30e. Each of the primary terminal 30d, primary terminal 30e, and diversity terminal 30f is connectable to each of the antenna terminal 30a, antenna terminal 30b, and diversity terminal 30c. The power amplifier 11 connects to one of the primary terminals 30d and 30e. The power amplifier 12 connects to the other one of the primary terminals 30d and 30e. The low-noise amplifier 13 connects to the primary terminal 30d or 30e. The diversity terminal 30f is connectable to a low-noise amplifier 20 included in a diversity module 2, which is a module different from the radio-frequency module 1. The diversity terminal 30c is connectable to an antenna terminal 40b included in the diversity module 2.

With this configuration, the radio-frequency module 1 can use the antenna 3c directly connected to the diversity module 2 when simultaneously transmitting multiple radio-frequency signals. That is, as a result of making the antenna 3c connectable to the radio-frequency module 1, the isolation between signals to be simultaneously transferred in the radio-frequency module 1 can be secured, thereby suppressing the degradation of the signal quality caused by intermodulation distortion. Additionally, since the number of antenna connection terminals disposed in the radio-frequency module 1 is reduced, the size of the radio-frequency module 1 is less likely to be increased. It is thus possible to provide a radio-frequency module 1 that is reduced in size and makes it less likely to degrade the signal quality during simultaneous transmission.

In one example, in the radio-frequency module 1, the primary terminal 30d may be connected to one of the antenna terminal 30a, antenna terminal 30b, and diversity terminal 30c; the primary terminal 30e may be connected to one of the antenna terminal 30a, antenna terminal 30b, and diversity terminal 30c which is not connected to the primary terminal 30d; and the diversity terminal 30f may be connected to one of the antenna terminal 30a, antenna terminal 30b, and diversity terminal 30c which is neither connected to the primary terminal 30d nor the primary terminal 30e.

With this configuration, when performing simultaneous transmission of a transmission signal of band A amplified in the power amplifier 11 and a transmission signal of band B amplified in the power amplifier 12, even with a band combination which causes intermodulation distortion, the isolation can be secured by suitably selecting two of the three antennas.

In one example, in the radio-frequency module 1, the primary terminal 30d may be connected to the antenna terminal 30a; the primary terminal 30e may be connected to the diversity terminal 30c; and the diversity terminal 30f may be connected to the antenna terminal 30b.

With this configuration, it is possible to implement simultaneous transmission of a transmission signal of band A amplified in the power amplifier 11 and a transmission signal of band B amplified in the power amplifier 12 by the use of the antenna 3a directly connected to the radio-frequency module 1 and the antenna 3c directly connected to the diversity module 2. The isolation can thus be secured by performing signal transmission with the use of different antennas.

In one example, in the radio-frequency module 1, the power amplifier 11 may amplify a signal of band A, and the power amplifier 12 may amplify a signal of band B.

This makes it possible to perform simultaneous transmission (ENDC and Inter-band CA) of a transmission signal of band A and a transmission signal of band B.

In one example, the radio-frequency module 1 may further include filters 51 and 53. The filter 51 is connected between the power amplifier 11 and the primary terminal 30d and has a pass band including band A. The filter 53 is connected between the power amplifier 12 and the primary terminal 30e and has a pass band including band B.

In one example, in the radio-frequency module 1, band A may be band B8 for LTE or band n8 for 5G-NR. Band B may be band B20, B1, or B3 for LTE or band n20, n1, or n3 for 5G-NR.

In the above-described band combinations, a frequency range in which intermodulation distortion occurs due to the interference of a transmission signal of band A and that of band B overlaps the receive band of band A or band B. However, the isolation can be secured by the use of different antennas, thereby suppressing the degradation of the reception sensitivity caused by intermodulation distortion.

In one example, in the radio-frequency module 1, band A may be band B13 for LTE or band n13 for 5G-NR, and band B may be band B26 for LTE or band n26 for 5G-NR.

In another example, in the radio-frequency module 1, band A may be band B2 for LTE or band n2 for 5G-NR, and band B may be band B66 for LTE or band n66 for 5G-NR.

In another example, in the radio-frequency module 1, band A may be band B1 for LTE or band n1 for 5G-NR, and band B may be band B3 for LTE or band n3 for 5G-NR.

In the above-described band combinations, a frequency range in which intermodulation distortion occurs due to the interference of a transmission signal of band A and that of band B overlaps the receive band of band A or band B. However, the isolation can be secured by the use of different antennas, thereby suppressing the degradation of the reception sensitivity caused by intermodulation distortion.

In one example, a radio-frequency module 1A according to the first modified example may further include a filter 55. The filter 55 is connected between the power amplifier 12 and the primary terminal 30e and has a pass band including band C.

With this configuration, the radio-frequency module 1A can use the antenna 3c directly connected to the diversity module 2 when performing simultaneous transmission of a transmission signal of band A and that of band C or a transmission signal of band B and that of band C. That is, as a result of making the antenna 3c connectable to the radio-frequency module 1A, the isolation between signals to be simultaneously transferred in the radio-frequency module 1A can be secured, thereby suppressing the degradation of the signal quality caused by intermodulation distortion. Additionally, since the number of antenna connection terminals disposed in the radio-frequency module 1A is reduced, the size of the radio-frequency module 1A is less likely to be increased. It is thus possible to provide a radio-frequency module 1A that is reduced in size and makes it less likely to degrade the signal quality during simultaneous transmission.

In one example, in the radio-frequency module 1A, band A may be band B8 for LTE or band n8 for 5G-NR, band B may be band B20 for LTE or band n20 for 5G-NR, and band C may be band B28 for LTE or band n28 for 5G-NR.

In the above-described band combinations, simultaneous transmission modes (1) ENDC of band B8 and band n28, (2) ENDC of band B28 and band n8, (3) CA of band n8 and band n28, (4) ENDC of band B20 and band n28, (5) ENDC of band B28 and band n20, and (6) CA of band n20 and band n28 can be implemented while securing the isolation by the use of different antennas.

In one example, in the radio-frequency module 1, the power amplifier 11 may amplify a signal of one of LTE and 5G-NR, and the power amplifier 12 may amplify a signal of the other one of LTE and 5G-NR.

With this configuration, when ENDC transmission is performed, the antennas 3a and 3b directly connected to the radio-frequency module 1 and the antenna 3c directly connected to the diversity module 2 are compared with each other, and the antennas 3a and 3b or the antenna 3c having a higher sensitivity can be used to transmit an LTE signal.

In one example, in the radio-frequency module 1, the power amplifier 11 may amplify a first channel signal of band A, and the power amplifier 12 may amplify a second channel signal of band A.

With this configuration, the radio-frequency module 1 can support simultaneous transmission of the same band (Intra-band_CA or Intra-band_ENDC).

In one example, the radio-frequency module 1 may be able to transmit a signal of a power class whose output power is higher than that of power class 2. A power class that the power amplifier 11 can support and a power class that the power amplifier 12 can support may be different from each other.

With this configuration, the radio-frequency module 1 is able to transmit a transmission signal of a high power class (power class 2 or higher).

In one example, the radio-frequency module 1 may be able to transmit a signal of a power class whose output power is higher than that of power class 2. The power amplifier 11 may amplify a first channel signal of band A, and the power amplifier 12 may amplify the first channel signal of band A. The primary terminal 30d may be connected to the antenna terminal 30a, and the primary terminal 30e may be connected to the antenna terminal 30a.

With this configuration, by using multiple transmit paths of the radio-frequency module 1 at the same time, even if neither of the power amplifier 11 nor the power amplifier 12 supports a high power class (power class 2 or higher), a transmission signal of a high power class (power class 2 or higher) can be transmitted.

A radio-frequency module 1B according to the third modified example includes a power amplifier 12, a low-noise amplifier 13, and a switch 30. The switch 30 includes antenna terminals 30a and 30b, diversity terminals 30c and 30f, and primary terminals 30d and 30e. Each of the primary terminal 30d, primary terminal 30e, and diversity terminal 30f is connectable to each of the antenna terminal 30a, antenna terminal 30b, and diversity terminal 30c. The power amplifier 12 connects to one of the primary terminals 30d and 30e. The low-noise amplifier 13 connects to the primary terminal 30d or 30e. The diversity terminal 30f is connectable to a power amplifier 21 and a low-noise amplifier 23 included in a diversity module 2B, which is a module different from the radio-frequency module 1B. The diversity terminal 30c is connectable to an antenna terminal 40b included in the diversity module 2B.

With this configuration, the radio-frequency module 1B can use the power amplifier 21 included in the diversity module 2B and the antenna 3c directly connected to the diversity module 2B when simultaneously transmitting multiple radio-frequency signals. That is, as a result of making the power amplifier 21 and the antenna 3c connectable to the radio-frequency module 1B, the isolation between signals to be simultaneously transferred in the radio-frequency module 1B can be secured, thereby suppressing the degradation of the signal quality caused by intermodulation distortion. Additionally, since the number of power amplifiers and that of antenna connection terminals disposed in the radio-frequency module 1B are reduced, the size of the radio-frequency module 1B is less likely to be increased. It is thus possible to provide a radio-frequency module 1B that is reduced in size and makes it less likely to degrade the signal quality during simultaneous transmission.

In one example, in the radio-frequency module 1B, one of the primary terminals 30d and 30e may be connected to the antenna terminal 30a, and the diversity terminal 30f may be connected to the antenna terminal 30b.

With this configuration, since the number of power amplifiers disposed in the radio-frequency module 1B is reduced, the size of the radio-frequency module 1B is less likely to be increased. Additionally, simultaneous transmission using both of the power amplifier 21 of the diversity module 2B and the power amplifier 12 of the radio-frequency module 1B is implemented, thereby lowering the heat generation in the radio-frequency module 1B.

In one example, a radio-frequency module 1C according to the fourth modified example may further include a power amplifier 11 connected to the other one of the primary terminals 30d and 30e which is not connected to the power amplifier 12.

With this configuration, when simultaneously transmitting multiple radio-frequency signals of different bands, the radio-frequency module 1C can use the power amplifiers 11 and 12 included in the radio-frequency module 1C and the power amplifier 21 included in the diversity module 2C. It is thus possible to provide a small radio-frequency module 1C that can simultaneously transmit three transmission signals (three uplink signals) and makes it less likely to degrade the signal quality during simultaneous transmission.

In one example, in the radio-frequency module 1C, one of the primary terminals 30d and 30e may be connected to the antenna terminal 30a, the other one of the primary terminals 30d and 30e may be connected to the diversity terminal 30c, and the diversity terminal 30f may be connected to the antenna terminal 30b.

With this configuration, simultaneous transmission of three uplink signals by using the power amplifiers 11 and 12 of the radio-frequency module 1C and the power amplifier 21 of the diversity module 2C can be implemented.

A radio-frequency module 1D according to the second modified example includes one of power amplifiers 11 and 12, a low-noise amplifier 13, and a switch 30. The other one of the power amplifiers 11 and 12 is included in a module 6 different from the radio-frequency module 1D. The switch 30 includes antenna terminals 30a and 30b, diversity terminals 30c and 30f, and primary terminals 30d and 30e. Each of the primary terminal 30d, primary terminal 30e, and diversity terminal 30f is connectable to each of the antenna terminal 30a, antenna terminal 30b, and diversity terminal 30c. One of the primary terminals 30d and 30e connects to one of the power amplifiers 11 and 12 which is included in the radio-frequency module 1D. The other one of the primary terminals 30d and 30e connects to the other one of the first and second power amplifiers 11 and 12 which is not included in the radio-frequency module 1D. The low-noise amplifier 13 connects to the primary terminal 30d or 30e. The diversity terminal 30f is connectable to a low-noise amplifier 20 included in a diversity module 2, which is a module different from the radio-frequency module 1D. The diversity terminal 30c is connectable to an antenna terminal 40b included in the diversity module 2.

With this configuration, the radio-frequency module 1D can use the antenna 3c directly connected to the diversity module 2 when simultaneously transmitting multiple radio-frequency signals. That is, as a result of making the antenna 3c connectable to the radio-frequency module 1D, the isolation between signals to be simultaneously transferred in the radio-frequency module 1D can be secured, thereby suppressing the degradation of the signal quality caused by intermodulation distortion. Additionally, since the number of antenna connection terminals disposed in the radio-frequency module 1D is reduced, the size of the radio-frequency module 1D is less likely to be increased. It is thus possible to provide a radio-frequency module 1D that is reduced in size and makes it less likely to degrade the signal quality during simultaneous transmission.

A communication device 5 according to the embodiment includes an RFIC 3 that processes a radio-frequency signal and the radio-frequency module 1 that transfers a radio-frequency signal between the RFIC 3 and the antennas 3a and 3b.

With this configuration, the communication device 5 can achieve advantages similar to the above-described advantages of the radio-frequency module 1.

### OTHER EMBODIMENTS

A radio-frequency module and a communication device according to an embodiment of the present disclosure have been discussed above through illustration of the embodiment and modified examples, but they are not restricted to the above-described embodiment and modified examples. Other embodiments implemented by combining certain elements in the above-described embodiment and modified examples and other modified examples obtained by making various modifications to the above-described embodiment and modified examples by those skilled in the art without departing from the scope and spirit of the disclosure are also encompassed in the disclosure. Various types of equipment integrating any of the above-described radio-frequency modules and communication devices are also encompassed in the disclosure.

In one example, in the circuit configurations of the radio-frequency modules and communication devices according to the above-described embodiment and modified examples, another circuit element and another wiring may be inserted onto a path connecting circuit elements and/or onto a path connecting signal paths illustrated in the drawings.

In the above-described embodiment and modified examples, bands for 5G-NR or LTE are used. In addition to or instead of 5G-NR or LTE, a communication band for another RAT may be used. For example, a communication band for a WLAN may be used. Additionally, a millimeter-wave band of 7 GHz or higher may be used. In this case, the radio-frequency module 1, antennas 3a, 3b, and 3c, and RFIC 3 may form a millimeter-wave antenna module, and a distributed-element filter may be used as a filter.

The present disclosure can be widely used in communication equipment, such as mobile phones, as a radio-frequency module disposed in a front-end section.

What is claimed is:

1. A radio-frequency module comprising:
a first power amplifier and a second power amplifier;
a first low-noise amplifier; and
a first switch, wherein
the first switch includes a first antenna terminal and a second antenna terminal, a first diversity terminal and a second diversity terminal, and a first primary terminal and a second primary terminal, each of the first primary terminal, the second primary terminal, and the first diversity terminal being switchably connectable to each of the first antenna terminal, the second antenna terminal, and the second diversity terminal,
the first power amplifier is switchably connected to one of the first primary terminal and the second primary terminal,
the second power amplifier is switchably connected to the other one of the first primary terminal and the second primary terminal,
the first low-noise amplifier is switchably connectable to the first primary terminal or the second primary terminal,
the first diversity terminal is switchably connectable to a second low-noise amplifier included in a diversity module, the diversity module being a module different from the radio-frequency module, and
the second diversity terminal is switchably connectable to a third antenna terminal included in the diversity module.

2. The radio-frequency module according to claim 1, wherein:
in the first switch,
the first primary terminal is switchably connected to one of the first antenna terminal, the second antenna terminal, and the second diversity terminal;
the second primary terminal is switchably connected to one of the first antenna terminal, the second antenna terminal, and the second diversity terminal which is not connected to the first primary terminal; and
the first diversity terminal is switchably connected to one of the first antenna terminal, the second antenna terminal, and the second diversity terminal which is neither connected to the first primary terminal nor the second primary terminal.

3. The radio-frequency module according to claim 1, wherein:
in the first switch,
the first primary terminal is connected to the first antenna terminal;
the second primary terminal is connected to the second diversity terminal; and
the first diversity terminal is connected to the second antenna terminal.

4. The radio-frequency module according to claim 1, wherein:
the first power amplifier is configured to amplify a signal of a first band; and
the second power amplifier is configured to amplify a signal of a second band.

5. The radio-frequency module according to claim 4, further comprising:
a first filter that is connected between the first power amplifier and the first primary terminal and has a pass band that includes the first band; and
a second filter that is connected between the second power amplifier and the second primary terminal and has a pass band that includes the second band.

6. The radio-frequency module according to claim 5, wherein:
the first band is band B8 for LTE (Long Term Evolution) or band n8 for 5G (5th Generation)-NR (New Radio); and
the second band is band B20, B1, or B3 for LTE or band n20, n1, or n3 for 5G-NR.

7. The radio-frequency module according to claim 5, wherein:
the first band is band B13 for LTE or band n13 for 5G-NR; and
the second band is band B26 for LTE or band n26 for 5G-NR.

8. The radio-frequency module according to claim 5, wherein:
the first band is band B2 for LTE or band n2 for 5G-NR; and
the second band is band B66 for LTE or band n66 for 5G-NR.

9. The radio-frequency module according to claim 5, wherein:
the first band is band B1 for LTE or band n1 for 5G-NR; and
the second band is band B3 for LTE or band n3 for 5G-NR.

10. The radio-frequency module according to claim 5, further comprising:
a third filter that is connected between the second power amplifier and the second primary terminal and has a pass band that includes a third band.

11. The radio-frequency module according to claim 10, wherein:
the first band is band B8 for LTE or band n8 for 5G-NR;
the second band is band B20 for LTE or band n20 for 5G-NR; and
the third band is band B28 for LTE or band n28 for 5G-NR.

12. The radio-frequency module according to claim 1, wherein:
the first power amplifier amplifies a signal of one of LTE and 5G-NR; and
the second power amplifier amplifies a signal of the other one of LTE and 5G-NR.

13. The radio-frequency module according to claim 1, wherein:
the first power amplifier is configured to amplify a first channel signal of a first band; and
the second power amplifier is configured to amplify a second channel signal of the first band.

14. The radio-frequency module according to claim 1, wherein:
the radio-frequency module is able to transmit a signal of a power class whose output power is higher than output power of power class 2; and
a power class that the first power amplifier is able to support and a power class that the second power amplifier is able to support are different from each other.

15. The radio-frequency module according to claim 1, wherein:
the radio-frequency module is configured to transmit a signal of a power class whose output power is higher than output power of power class 2;
the first power amplifier is configured to amplify a first channel signal of a first band;
the second power amplifier is configured to amplify the first channel signal of the first band; and
in the first switch, the first primary terminal is connected to the first antenna terminal, and the second primary terminal is connected to the first antenna terminal.

16. A radio-frequency module comprising:
a first power amplifier;
a first low-noise amplifier; and
a first switch, wherein
the first switch includes a first antenna terminal and a second antenna terminal, a first diversity terminal and a second diversity terminal, and a first primary terminal and a second primary terminal, each of the first primary terminal, the second primary terminal, and the first diversity terminal being switchably connectable to each of the first antenna terminal, the second antenna terminal, and the second diversity terminal,
the first power amplifier is switchably connected to one of the first primary terminal and the second primary terminal,
the first low-noise amplifier is switchably connected to the first primary terminal or the second primary terminal,
the first diversity terminal is switchably connectable to a second power amplifier and a second low-noise amplifier included in a diversity module, the diversity module being a module different from the radio-frequency module, and
the second diversity terminal is switchably connectable to a third antenna terminal included in the diversity module.

17. The radio-frequency module according to claim 16, wherein:
in the first switch,
one of the first primary terminal and the second primary terminal is switchably connected to the first antenna terminal; and
the first diversity terminal is switchably connected to the second antenna terminal.

18. The radio-frequency module according to claim 16, further comprising:
a third power amplifier connected to the other one of the first primary terminal and the second primary terminal.

19. The radio-frequency module according to claim 18, wherein:
in the first switch,
one of the first primary terminal and the second primary terminal is connected to the first antenna terminal;
the other one of the first primary terminal and the second primary terminal is connected to the second diversity terminal; and
the first diversity terminal is connected to the second antenna terminal.

20. A radio-frequency module comprising:
one of a first power amplifier and a second power amplifier;
a first low-noise amplifier; and
a first switch, wherein
the other one of the first power amplifier and the second power amplifier is included in a module different from the radio-frequency module,
the first switch includes a first antenna terminal and a second antenna terminal, a first diversity terminal and a second diversity terminal, and a first primary terminal and a second primary terminal, each of the first primary terminal, the second primary terminal, and the first diversity terminal being switchably connectable to each of the first antenna terminal, the second antenna terminal, and the second diversity terminal,
one of the first primary terminal and the second primary terminal is switchably connected to one of the first power amplifier and the second power amplifier which is included in the radio-frequency module,
the other one of the first primary terminal and the second primary terminal is switchably connected to the other one of the first power amplifier and the second power amplifier,
the first low-noise amplifier is switchably connected to the first primary terminal or the second primary terminal,
the first diversity terminal is switchably connectable to a second low-noise amplifier included in a diversity module, the diversity module being a module different from the radio-frequency module, and
the second diversity terminal is switchably connectable to a third antenna terminal included in the diversity module.
